(19) United States
(12) Patent Application Publication
(10) Pub. No.: US 2009/0236878 A1
(43) Pub. Date: Sep. 24, 2009

(54) OPENABLE VEHICLE ROOF

(76) Inventor: Rainer Grimm, Frankfurt (DE)

Correspondence Address: CARLSON, GASKEY & OLDS, P.C., 400 WEST MAPLE ROAD, SUITE 350, BIRMINGHAM, MI, 48009, US

(21) Appl. No.: 12/397,532

(22) Filed: Mar. 4, 2009

(30) Foreign Application Priority Data
Mar. 18, 2008 (EP) 08005053.7

(51) Int. Cl. B60J 7/02; B60J 7/00

(52) U.S. Cl. 296/217; 296/224

(57) ABSTRACT

An openable vehicle roof with a roof opening and a movable cover has a wind deflector which is attached pivotably to a fixed shaft located under an opening edge. A wind deflector mechanism, which can be coupled to a movement mechanism of the cover, is also located under the opening edge.

### RELATED APPLICATION

This application claims priority to European Application No. 08005053.7, which was filed Mar. 18, 2008.

### TECHNICAL FIELD

The invention relates to an openable vehicle roof with a roof opening that can optionally be opened and closed by a movable cover. The roof opening is delimited by an opening edge of the roof, and a wind deflector, when in an open state of the movable cover, protrudes upward behind a front opening edge. The wind deflector is spring-mounted.

### BACKGROUND OF THE INVENTION

A vehicle roof of the type in question is known from DE 25 05 736 A1. This vehicle roof has a type of rocker below the front opening edge, on which, in turn, a pivot shaft for the wind deflector is seated. The rocker can be actuated by a spring-loaded lever. The lever, in turn, can be passed over by an extension of the cover, which results in an initiation of downward pivoting movement. The wind deflector seated on the rocker is movable via a further spring mechanism and pivots to the rear as soon as the movable cover is drawn back. At the same time, the rocker is pivoted upward via the spring loaded lever, as a result of which the wind deflector is deployed upward over the opening edge.

The invention relates exclusively to vehicle roofs in which, in the closed state of the roof, the wind deflectors are located below the roof skin and subsequently, during the opening of the roof, emerge over the front edge.

It is the object of the invention to provide a more simply constructed roof.

### SUMMARY OF THE INVENTION

This is achieved by a roof of the type initially mentioned in that the wind deflector can be pivoted about a fixed shaft which, in the pivoted-out position of the wind deflector, is located (as seen in top view) entirely below the front opening edge. Pivoting into the retracted position takes place by a wind deflector mechanism which (in top view) is located below the opening edge and is coupled, or can be coupled, to a movement mechanism of the cover.

In one example, one pivot shaft is provided, rather than a plurality of pivot shafts located one on another, and therefore it is necessary to combine a plurality of pivoting movements. This means that the wind deflector itself is coupled directly to a fixed shaft and not, for example, to a shaft seated on a rocker or another lever. This simplifies the movement sequences and the entire mechanism is therefore more robust. Furthermore, the wind deflector mechanism, by which the wind deflector is pivoted in when the cover is being closed, is also located below the opening edge. Therefore, when the vehicle roof is open, the vehicle opening is first not constricted, and second is more or less invisible to the occupant, which improves the overall aesthetic impression. The pivoting-in movement is derived from the movement mechanism of the cover, and therefore a dedicated drive is unnecessary and there is “forced coupling”. When the roof is closed, the wind deflector is inevitably pivoted downward again.

The wind deflector mechanism, i.e. the parts which are coupled to the wind deflector and are movable with respect thereto, are preferably designed as a linkage. A linkage can be produced in a stable and simple manner.

In the pivoted-out state of the wind deflector, the linkage is preferably entirely decoupled from the movement mechanism of the cover.

During moving of the cover into the closed position, the movement mechanism preferably moves toward the linkage and displaces the latter in order to bring about the pivoting-in movement.

A very simple embodiment is achieved in that the linkage has a lever which, in the pivoted-out state of the wind deflector, stands vertically (i.e. substantially vertically), and a pressure element which is coupled to the lever and is connected to the wind deflector. Very few parts are therefore required in order to ensure all of the movements of the wind deflector.

Of course, the entire pivoting mechanism should not be provided on one side edge, but rather symmetrically on both side edges and should therefore be present at both lateral ends of the wind deflector.

The previously mentioned lever can be bent laterally, as seen in the direction of the vehicle, with the pressure element lying in a bend. By this bending, the lever can be better adapted to the adjacent components, which saves on space laterally, and, in addition, the pressure element can lie in such a bend, which also reduces space problems.

In one example embodiment, during closing of the cover from the open position, a slotted guide of the cover strikes against the wind deflector mechanism and displaces the latter. The slotted guide can be a fixed, i.e. non-pivotable, part which is coupled rigidly to the cover. Furthermore, of course, other parts are also conceivable which are coupled or can be coupled to the cover, and either only follow the movement of the cover or execute a movement relative thereto.

The slotted guide can have a laterally protruding stop to strike against the wind deflector mechanism, preferably against the previously mentioned lever.

The movement mechanism can move under the lever and pivot the lever, wherein, in the retracted position of the wind deflector, the lever is then pressed from above against the movement mechanism and is held in a pivoted position.

The wind deflector mechanism should be accommodated laterally outside the slotted guide of the cover, i.e. closer toward the outside of the vehicle, and therefore at a location which is relatively protected against dirt.

Preferably, only the deployment spring moves the wind deflector into the pivoted-out position, i.e. a drive for raising it is otherwise not required. Of course, a respective deployment spring should be provided at both ends of the wind deflector in order not to cause any tilting of the wind deflector.

These and other features of the present invention can be best understood from the following specification and drawings, the following of which is a brief description.

### BRIEF DESCRIPTION OF THE DRAWINGS

FIG. 1 shows a perspective top view of an openable vehicle roof according to the invention,

FIG. 2 shows a longitudinal sectional view through the vehicle roof along the line II-II in FIG. 1 in a region of a front opening edge when the cover is closed,

FIG. 3 shows a corresponding sectional view through the roof according to the invention when the cover is lowered,

FIG. 4 shows a sectional view through the vehicle roof in a ventilation position,

FIG. 5 shows a sectional view through the vehicle roof when the roof is virtually or completely open, and

FIG. 6 shows a cross-sectional view through the vehicle roof in a region of a lateral opening edge.

### DETAILED DESCRIPTION OF THE PREFERRED EMBODIMENT

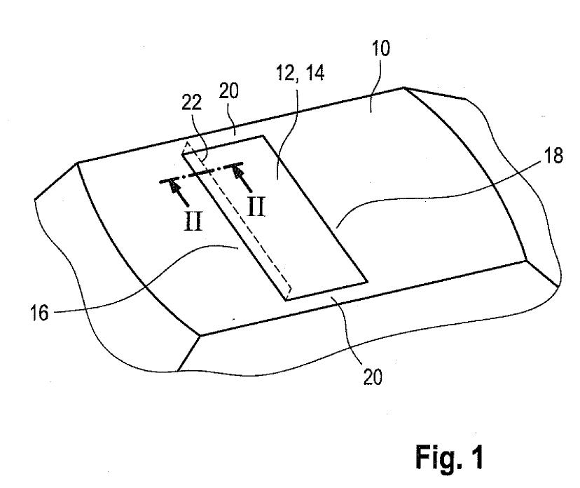

FIG. 1 illustrates an openable vehicle roof 10 which has a roof opening 12 that can optionally be opened and closed by a deployable and movable cover 14. The roof opening 12 is delimited by an encircling opening edge which comprises a front opening edge 16 running transversely with respect to a direction of the vehicle, a rear opening edge 18, and lateral opening edges 20.

The cover 14, when being moved back, is moved either over the roof 10 or under the roof 10, with the latter being more customary. In order to optimize the noise levels, and in particular, the air flow in an interior of the vehicle, during the raising of the cover 14 a wind deflector 22 is pivoted upward over the front opening edge 16 and directly adjacent thereto. The wind deflector 22 preferably extends over an entire width of the opening 12.

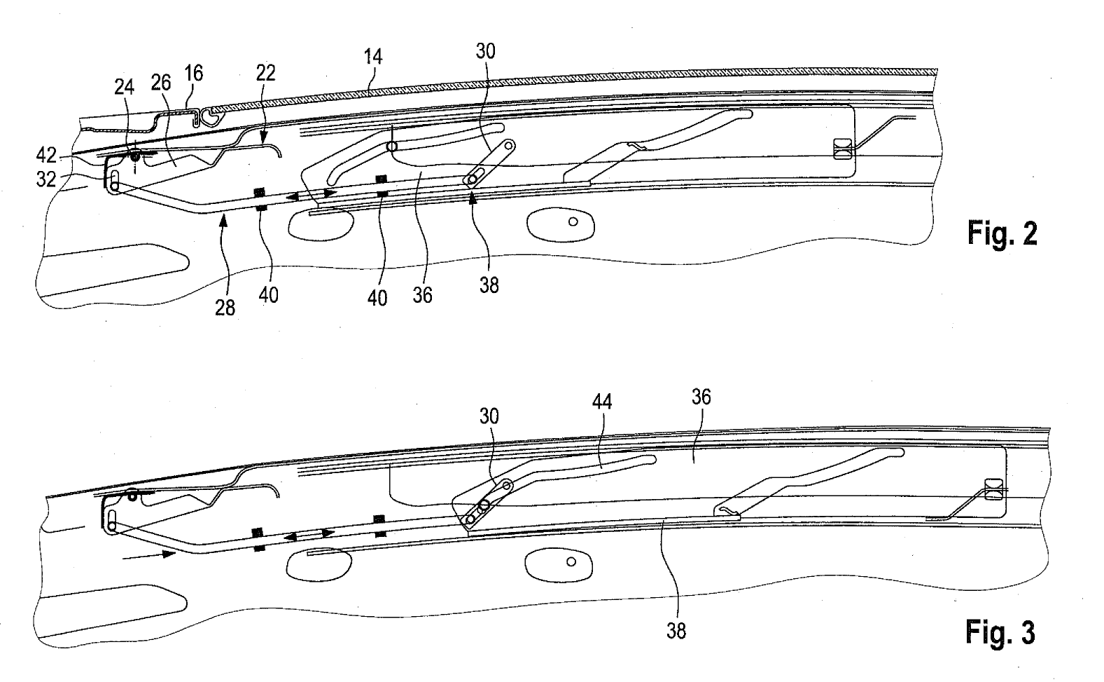

The construction of the wind deflector mechanism and of the wind deflector itself can be seen in FIG. 2. The wind deflector 22, also called a wind deflector leaf, is attached pivotably to a fixed, i.e. spatially fixed, shaft 24. The shaft 24 is always located, i.e. even in a pivoted-out position of the wind deflector 22, below the front opening edge 16, i.e. the shaft 24 cannot be seen from above. The wind deflector 22 comprises various sections, namely a continuous section running transversely with respect to the direction of the vehicle, and also comprises two arms 26 which are present on the lateral edges of the wind deflector 22 and extend with respect to the particular shaft 24. The wind deflector 22 thus forms a two-armed lever.

The wind deflector mechanism is attached to the lower part of the lever.

In the present case, the wind deflector mechanism only comprises very few parts per side, namely a pressure element 28 in the form of a rod, and a lever 30, in particular a single-armed lever, which is coupled pivotably to the pressure element 28. The wind deflector 22 is coupled pivotably to the pressure element 28, namely via a short elongated hole 32.

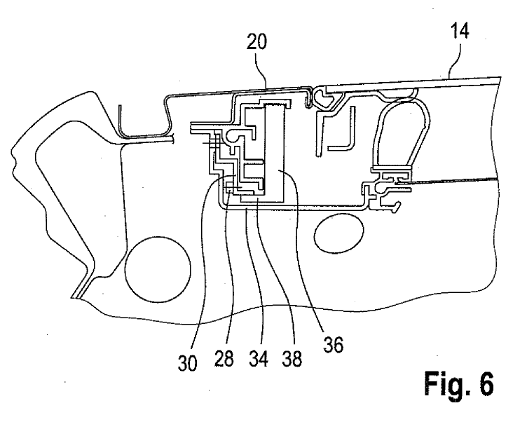

As can be gathered from FIG. 6, the lever 30 is directly attached pivotably to the frame 34 of the roof.

It can also be gathered from FIG. 6 that the lever 30 is bent a number of times and the pressure element 28 is seated in a bend.

The wind deflector mechanism is arranged laterally outside a slotted guide 36 of the “movement mechanism” of the cover 14. At the lower end, the slotted guide 36 has a stop 38 which protrudes laterally in the direction of the lever 30 and, as FIG. 2 shows, runs virtually over an entire lower edge of the slotted guide 36.

In this region, the lever 30 also has a bend, with the lower side of which it bears against the upper side of the stop 38, to be precise in all states except for the pivoted-out state of the wind deflector 22.

As can furthermore be seen in FIG. 2, the pressure element 28 is mounted on the frame 34 via guides 40 in a manner such that it can be displaced in the longitudinal direction.

Furthermore, it should also be mentioned that a spring 42, here a leg spring, acts directly on the wind deflector 22 and endeavors to press the wind deflector 22 into its pivoted-out position.

In the position illustrated in FIG. 2, the cover 14 is closed, the wind deflector 22 is pivoted downward, and the lever 30 rests on the stop 38. Since the spring mounting of the wind deflector 22 endeavors to press the latter upward, the pressure element 28 also endeavors to be displaced to the right in order to pivot the lever 30 counterclockwise. Since, however, the lever 30 rests on the stop 38, the latter keeps the wind deflector mechanism in the position illustrated.

For simplification in FIG. 3, the cover 14 and the opening edge 16 have been omitted. In the embodiment according to FIG. 3, the cover 14 is lowered in order to be able to be moved to the rear under the roof skin. The slotted guide 36 with its slotted guide mechanism 44, which is responsible for the vertical movement of the cover 14, is moved to the rear in this position. However, the lever 30 still bears against the stop 38.

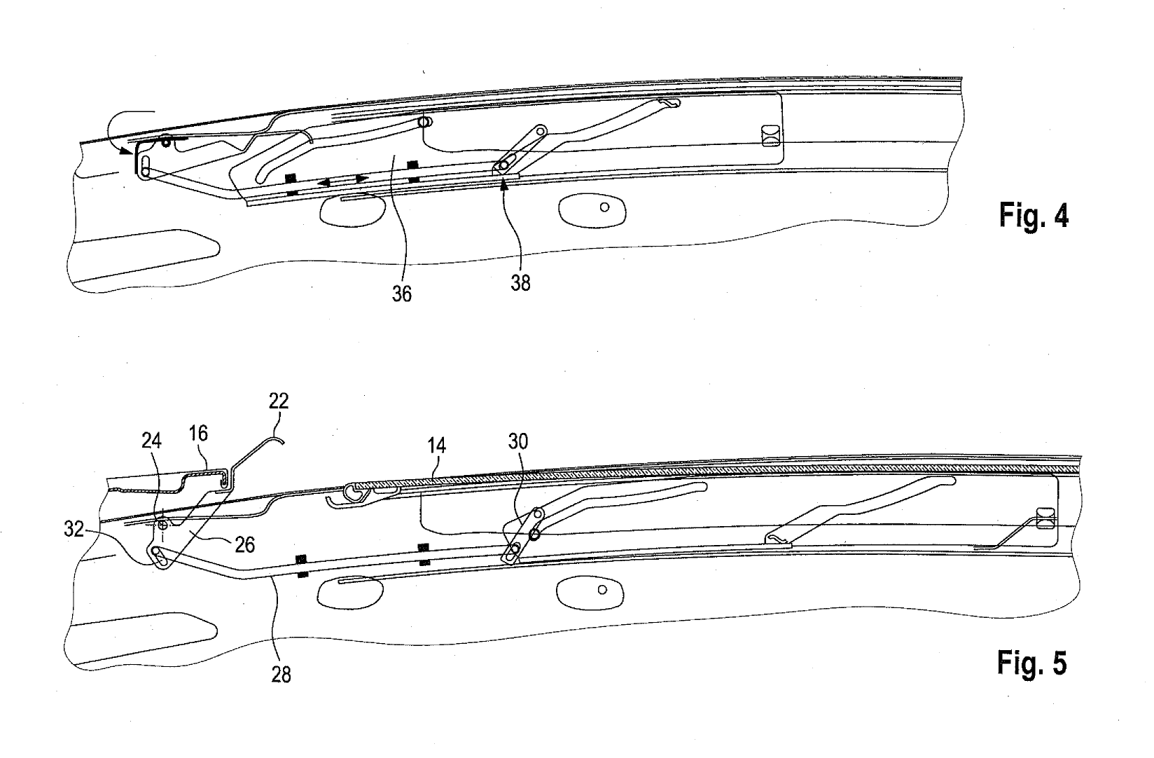

In the position shown in FIG. 4, the slotted guide 36 has been moved forward to a very great extent, since the cover (omitted here) is in the “ventilation position,” i.e. in the deployed position in which the rear edge has pivoted upward. Even in this position, the lever 30 still bears against the stop 38, but against the outer, rear end thereof.

If the cover 14 is moved still further to the rear for complete opening (see FIG. 5), the stop 38 under the lever 30 moves away such that the lever 30 can be pivoted counterclockwise, on account of the spring 42 which is not illustrated in FIG. 5. The wind deflector 22 therefore pivots into the deployed position illustrated in FIG. 5.

If the cover 14 is again moved to the left into the closed position, the stop 38 strikes again against the lever 30 and pivots the lever 30 in the clockwise direction such that the lever 30 finally sits on the stop 38 again.

As illustrated, the wind deflector linkage is decoupled in the pivoted-out position of the wind deflector 22 from the “movement mechanism” of the cover 14, in the present case from the slotted guide 36.

In the entirely open state of the cover 14, the lever 30 stands substantially vertically.

The following should also be emphasized:

The wind deflector 22 is pivoted exclusively via the two springs 42 which act in the region of the shaft 24 and are also responsible for the position of the wind deflector mechanism.

In the open state of the roof, both the wind deflector mechanism and the shaft 24 are located, as seen in top view, below the opening edge, i.e. cannot be seen from above and therefore do not restrict the opening 12. According to the preferred embodiment, even the arms 26 are located below the opening edge 16, and the pressure elements 28 are located under the opening edges 20 and with respect to the part.

Although an embodiment of this invention has been disclosed, a worker of ordinary skill in this art would recognize that certain modifications would come within the scope of this invention. For that reason, the following claims should be studied to determine the true scope and content of this invention.

What is claimed is:

1. An openable vehicle roof comprising:
a roof opening that can selectively be opened and closed by a movable cover, wherein the roof opening is delimited by an opening edge of the movable cover;
a wind deflector which, in an open state of the roof opening, protrudes upward behind a front opening edge, and wherein the wind deflector is spring-mounted and can be pivoted about a fixed shaft which, in a pivoted-out position of the wind deflector, is located entirely below the front opening edge; and
a wind deflector mechanism that is located below the opening edge, and which pivots the wind deflector into a retracted position, the wind deflector mechanism adapted to be coupled to a movement mechanism of the movable cover.

2. The openable vehicle roof as claimed in claim 1, wherein the wind deflector mechanism is a linkage.

3. The openable vehicle roof as claimed in claim 2, wherein, in the pivoted-out position of the wind deflector, the linkage is entirely decoupled from the movement mechanism.

4. The openable vehicle roof as claimed in claim 2, wherein, during closing of the roof opening, the movement mechanism moves toward the linkage and displaces the linkage to bring about a pivoting-in movement.

5. The openable vehicle roof as claimed in one of claims 2, wherein the linkage has a lever which, in the pivoted-out position of the wind deflector, stands vertically, and a pressure element that is coupled to the lever and is connected to the wind deflector.

6. The openable vehicle roof as claimed in claim 5, wherein the lever is bent laterally and the pressure element lies in a bend.

7. The openable vehicle roof as claimed in claim 1, wherein the movement mechanism has a slotted guide which, during closing of the movable cover, strikes against the wind deflector mechanism and displaces the wind deflector mechanism.

8. The openable vehicle roof as claimed in claim 7, wherein the slotted guide has a laterally protruding stop that strikes against the wind deflector mechanism.

9. The openable vehicle roof as claimed in claim 1, wherein the movement mechanism pivots a lever of the wind deflector mechanism.

10. The openable vehicle roof as claimed in claim 9, wherein the movement mechanism pivots the lever of the wind deflector mechanism and, in a pivoted-in position of the wind deflector, the lever presses from above against the movement mechanism and is held in the pivoted position.

11. The openable vehicle roof as claimed in claim 1, wherein the wind deflector mechanism is located laterally outside the movement mechanism of the movable cover.

12. The openable vehicle roof as claimed in claim 1, wherein the wind deflector is brought into the pivoted-out position exclusively via springs coupled directly to the wind deflector.

13. The openable vehicle roof as claimed in claim 11, wherein the movement mechanism has a slotted guide, and wherein the wind deflector mechanism is located laterally outside the slotted guide.

14. The openable vehicle roof as claimed in claim 1 wherein the both the wind deflector mechanism and the fixed shaft are located, as seen in top view, below the opening edge and cannot be seen from above the roof opening.
